(19) United States
(12) Patent Application Publication
(10) Pub. No.: US 2025/0383449 A1
(43) Pub. Date: Dec. 18, 2025

(54) Detection Apparatus and Methods of Use

(71) Applicant: Artilux, Inc., Menlo Park, CA (US)

(72) Inventors: Yu-Hsuan Liu, Hsinchu County (TW); Yi-Chuan Teng, Hsinchu County (TW); Chih-Hao Cheng, Hsinchu County (TW); Shih-Jou Huang, Hsinchu County (TW); Che-Fu Liang, Hsinchu County (TW); Shu-Lu Chen, Hsinchu County (TW); Neil Y. Na, San Jose, CA (US); Chien-Lung Chen, Hsinchu County (TW)

(21) Appl. No.: 19/232,459

(22) Filed: Jun. 9, 2025

Related U.S. Application Data
(60) Provisional application No. 63/660,573, filed on Jun. 17, 2024.

(51) Int. Cl. G01S 17/894; G01S 7/481; G01S 7/4861; G01S 7/4865

(52) U.S. Cl. CPC G01S 17/894; G01S 7/4815; G01S 7/4816; G01S 7/4861; G01S 7/4865

(57) ABSTRACT

An object detection apparatus includes: first and second light-emitting modules configured to emit first and second types of light toward an object, a pixel array of a plurality of photodetectors including first and second sub-arrays for receiving the first and second types of light, and a processing circuit including a first circuit coupled to the first sub-array and a second circuit coupled to the second sub-array. The pixel array includes a first sub-array configured to receive the first type of light and a second sub-array configured to receive the second type of light. The processing circuit: activates the first light-emitting module to determine a distance information, activate the second light-emitting module to determine a 3D imaging information, and obtain a surface topography information of the object based on the distance information and the 3D imaging information.

### PRIORITY CLAIM

The subject application claims the benefit of priority to U.S. Provisional Patent Application No. 63/660,573 filed on Jun. 17, 2024, entitled “DETECTION APPARATUS AND METHODS OF USE THEREOF,” which is incorporated by reference herein in its entirety for all purposes.

### FIELD

The present disclosure relates generally to object detection systems and methods with the function of detecting the surface topography of objects.

### BACKGROUND

A detection system with the function of detecting the surface topography of objects can be used in various applications, such as autonomous driving, mobile robots, space landing aircraft, drones, etc., and usually needs to be equipped with multiple detection devices. For example, a ranging detector (altimeter) is required to obtain distance information to an object, and an area-sensing detector is needed to obtain 3D imaging information of the object when the detection system is close to the object to a suitable distance. The detection system can gather the distance information and the 3D imaging information into the surface topography information of the object in a field of view. In this way, the detection system requires at least two independent detectors, which increases the complexity of the system design of the detection system.

### SUMMARY

The present disclosure relates to a detection apparatus and a method for operating the same. The detection apparatus is a LiDAR (light detection and ranging) apparatus with a dual function that uses non-contact optical measurement to perform the ranging function and the area-sensing function. The detection apparatus uses a ranging function to measure the distance information to an object, and an area-sensing function to obtain 3D imaging information of the object. Then, the detection apparatus can determine the surface topography information of the object through continuously measured distance information and 3D imaging information.

Aspects and advantages of embodiments of the present disclosure will be set forth in part in the following description, or may be learned from the description, or may be learned through practice of the embodiments.

One example aspect of the present disclosure is directed to a detection apparatus configured to detect an object. The detection apparatus includes a first light-emitting module configured to emit a first type of light toward the object. The detection apparatus includes a second light-emitting module configured to emit a second type of light toward the object. The detection apparatus includes a pixel array including a plurality of photodetectors, wherein the pixel array includes a first sub-array configured to receive the first type of light and a second sub-array configured to receive the second type of light. The detection apparatus includes a processing circuit including a first circuit coupled to the first sub-array and a second circuit coupled to the second sub-array. The processing circuit is configured to activate the first light-emitting module to emit the first type of light toward the object. The processing circuit is configured to process, by the first circuit and from the first sub-array, a portion of the first type of light reflected from the object to determine a distance information to the object. The processing circuit is configured to determine that the detection apparatus has reached a particular distance from the object according to the distance information. In response to determining that the detection apparatus has reached the particular distance, the processing circuit is configured to activate the second light-emitting module to emit the second type of light toward the object. The processing circuit is configured to process, by the second circuit and from the second sub-array, a portion of the second type of light reflected from the object to determine a 3D imaging information. The processing circuit is configured to obtain a surface topography information of the object based on the distance information and the 3D imaging information.

In some implementations, the detection apparatus includes a guiding element configured to guide the detection apparatus to reach the particular distance from the object.

In some implementations, the guiding element determines a landing zone for a vehicle that includes the detection apparatus according to the surface topography information.

In some implementations, the processing circuit is configured to deactivate the second light-emitting module to emit the second type of light until the detection apparatus has reached the particular distance.

In some implementations, the pixel array, the first circuit, and the second circuit are integrated to form a light detector.

In some implementations, the pixel array is a time-of-flight sensor.

In some implementations, at least one of the first light-emitting module and the second light-emitting module includes a Q-switched laser.

In some implementations, the plurality of photodetectors includes SPAD.

In some implementations, the plurality of photodetectors includes germanium.

In some implementations, the first type of light is pulse light and the second type of light is flash type of light.

In some implementations, the first light-emitting module and the second light-emitting module operate in SWIR band.

In some implementations, the first light-emitting module includes an optical element to split the first type of light into array beams for ranging.

In some implementations, the pixel array includes a plurality of the first sub-array to receive a portion of the array beams reflected from the object.

In some implementations, the first type of light is at a first wavelength and the second type of light is at a second wavelength different from the first wavelength.

In some implementations, the first circuit includes a first quench circuit, a coincidence circuit coupled to the first quench circuit, and a first time-to-digital converter coupled to the coincidence circuit to determine the distance information.

In some implementations, the second circuit includes a plurality of sub-circuits corresponding to each line of the pixel array, each sub-circuit including a second quench circuit, a decoder coupled to the second quench circuit, and a second time-to-digital converter coupled to the decoder to determine the 3D imaging information.

Another example aspect of the present disclosure is directed to a method for ranging and area-sensing by a detection apparatus. The method includes activating, by a processing circuit, a first light-emitting module to emit a first type of light toward an object for ranging. The method includes activating, by the processing circuit, a light-receiving module to receive a portion of the first type of light reflected from the object to determine a distance information to the object. The method includes determining, by the processing circuit, the detection apparatus has reached a particular distance from the object according to the distance information. The method includes in response to determining that the detection apparatus has reached the particular distance, activating, by the processing circuit, a second light-emitting module to emit a second type of light toward the object for area-sensing. The method includes activating, by the processing circuit, the light-receiving module to receive a portion of the second type of light reflected from the object to determine 3D imaging information of the object. The method includes obtaining, by the processing circuit, a surface topography information of the object based on the 3D imaging information and the distance information.

In some implementations, the method includes deactivating, by the processing circuit, the second light-emitting module to emit the second type of light until the detection apparatus has reached the particular distance.

In some implementations, the method includes determining a landing zone for a vehicle that includes the detection apparatus according to the surface topography information.

In some implementations, the light-receiving module includes SPAD.

Yet another aspect of the present disclosure is directed to a method for adjusting a SNR of a detection apparatus, wherein the detection apparatus includes a plurality of SPADs. The method includes calculating, by one or more processing circuits, an initial SNR and a total count based on a histogram. The method includes determining, by one or more processing circuits, that the total count is more than a threshold. In response to determining that the total count is more than the threshold, the method includes outputting, by one or more processing circuits, a first control signal to decrease a PDE of the SPADs.

In some implementations, the method includes determining, by one or more processing circuits, that the total count is less than the threshold, and in response to determining that the total count is less than the threshold, outputting, by one or more processing circuits, a second control signal to increase the PDE of the SPADs.

In some implementations, the method includes determining, by one or more processing circuits, that the total count is less than the threshold, and in response to determining that the total count is less than the threshold, determining that the total count is less than a lower threshold, and in response to determining that the total count is less than the lower threshold, outputting, by one or more processing circuits, a second control signal to increase the PDE of the SPADs.

In some implementations, in response to determining that the total count is more than the threshold, the method includes updating, by one or more processing circuits, an updated SNR based on a current histogram, determining, by one or more processing circuits, that the updated SNR is more than the initial SNR, and in response to determining that the updated SNR is more than the initial SNR, outputting, by one or more processing circuits, a third control signal to decrease the PDE of the SPADs.

In some implementations, the method includes determining, by one or more processing circuits, that the updated SNR is not more than the initial SNR, and in response to determining that the updated SNR is not more than the initial SNR, outputting, by one or more processing circuits, a fourth control signal to increase the PDE of the SPADs.

In some implementations, in response to determining that the total count is less than the threshold, the method includes updating, by one or more processing circuits, an updated SNR based on a current histogram, determining, by one or more processing circuits, that the updated SNR is more than the initial SNR, and in response to determining that the updated SNR is more than the initial SNR, outputting, by one or more processing circuits, a fifth control signal to increase the PDE of the SPADs.

In some implementations, the method includes determining, by one or more processing circuits, that the updated SNR is not more than the initial SNR, and in response to determining that the updated SNR is not more than the initial SNR, outputting, by one or more processing circuits, a sixth control signal to decrease the PDE of the SPADs.

In some implementations, decreasing the PDE is based on an adjustment, and the adjustment includes controlling an excess bias voltage applied to the SPADs.

In some implementations, decreasing the PDE is based on an adjustment, and the adjustment includes altering a focusing spot size in relation to a lens position.

In some implementations, decreasing the PDE is based on an adjustment, and the adjustment includes adjusting light transmission efficiency of a variable attenuator, wherein the variable attenuator is disposed above the SPADs.

In some implementations, decreasing the PDE is based on an adjustment, and the adjustment includes adjusting a lens iris, wherein the lens iris is disposed above the SPADs.

Other example aspects of the present disclosure are directed to systems, methods, apparatuses, sensors, computing devices, tangible non-transitory computer-readable media, and memory devices related to the described technology.

These and other features, aspects and advantages of various embodiments will become better understood with reference to the following description and appended claims. The accompanying drawings, which are incorporated in and constitute a part of this specification, illustrate embodiments of the present disclosure, and together with the description, serve to explain the related principles.

### BRIEF DESCRIPTION OF THE DRAWINGS

The foregoing aspects and many of the advantages of this application will become more readily appreciated as the same becomes better understood by reference to the following detailed description, when taken in conjunction with the accompanying drawings:

FIG. 1A shows a cross-sectional view of a detection apparatus in accordance with one embodiment of the present disclosure.

FIG. 1B shows a top view of a light detector of the detection apparatus in accordance with one embodiment of the present disclosure.

FIG. 2A shows a schematic of a vehicle including a detection apparatus in accordance with one embodiment of the present disclosure.

FIG. 2B shows a schematic of a first circuit of the processing circuit of the detection apparatus in accordance with one embodiment of the present disclosure.

FIG. 2C shows a schematic of a second circuit of the processing circuit of the detection apparatus in accordance with one embodiment of the present disclosure.

FIG. 3 shows a flow for determining a surface topography information of an object of a detection apparatus in accordance with one embodiment of the present disclosure.

FIG. 4A shows a view of a detection apparatus in accordance with another embodiment of the present disclosure.

FIG. 4B shows a top view of an optical sensor of the detection apparatus in accordance with another embodiment of the present disclosure.

FIG. 5A shows a view of a detection apparatus in accordance with another embodiment of the present disclosure.

FIG. 5B shows a top view of a light detector of the detection apparatus in accordance with another embodiment of the present disclosure.

FIG. 6A shows a flow for adjusting SNR of a detection apparatus in accordance with one embodiment of the present disclosure.

FIG. 6B shows a flow for adjusting SNR of a detection apparatus in accordance with another embodiment of the present disclosure.

### DETAILED DESCRIPTION

The following embodiments accompany the drawings to illustrate the concept of the present disclosure. In the drawings or descriptions, similar or identical parts use the same reference numerals, and in the drawings, the shape, thickness, or height of the element can be reasonably expanded or reduced. The embodiments listed in the present application are only used to illustrate the present application and are not used to limit the scope of the present application. Any obvious modification or change made to the present application does not depart from the spirit and scope of the present application.

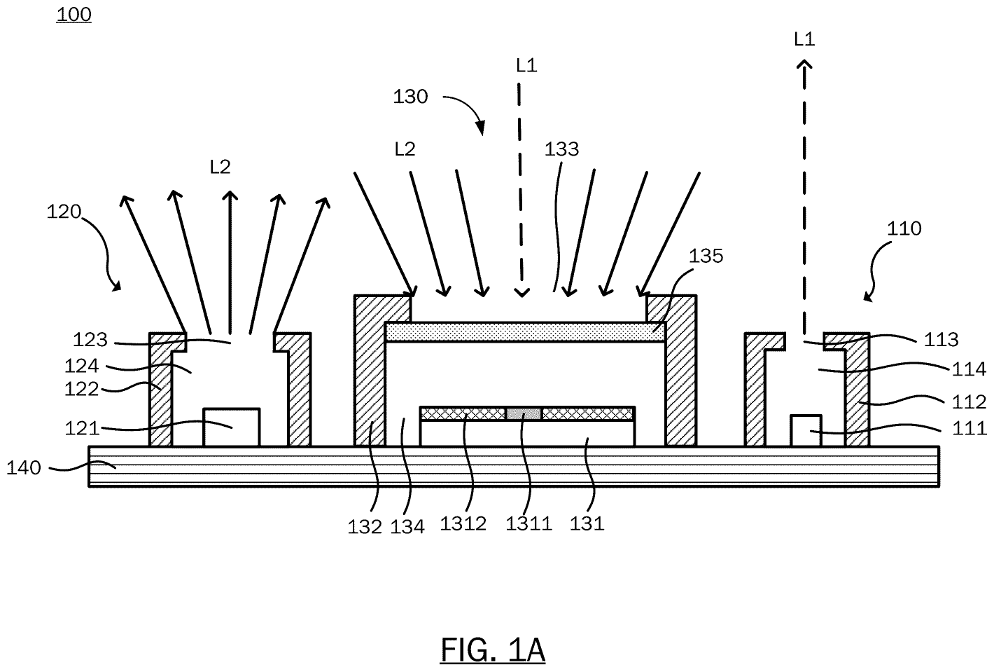

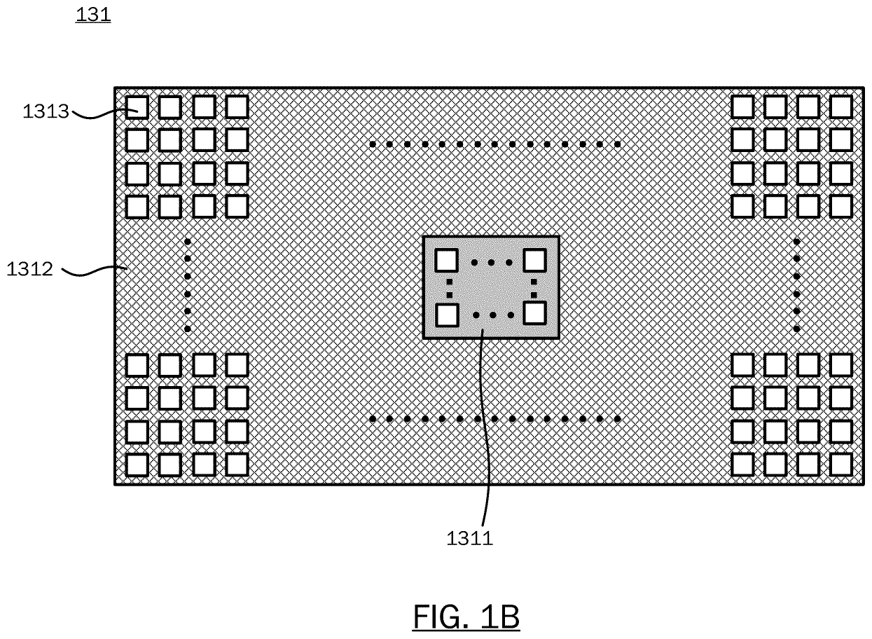

FIG. 1A shows a cross-sectional view of a detection apparatus in accordance with one embodiment of the present disclosure. The detection apparatus 100 includes a first light-emitting module 110, a second light-emitting module 120, a light-receiving module 130, and a carrier 140. The first light-emitting module 110, the light-receiving module 130, and the second light-emitting module 120 are located on and electrically connected to the carrier 140. The first light-emitting module 110 is configured to emit the first type of light for ranging. The second light-emitting module 120 is configured to emit the second type of light for area-sensing. When the detection apparatus 100 performs the ranging function, the first light-emitting module 110 is configured to emit the first type of light toward the object, and the light-receiving module 130 detects the reflected first type of light from the object to determine the distance information based on the time it takes for the reflected light to return. The first type of light can be a pulse light with a small FOI (field of illumination) for long-range detection. In an embodiment, the detection distance may be several kilometers to hundreds of meters, and the first type of light may be a high-power and focused pulsed laser to provide accurate and fast measurement. When the detection apparatus 100 performs the area-sensing function, the second light-emitting module 120 is configured to emit the second type of light toward the object, and the light-receiving module 130 detects the reflected second type of light from the object to determine the 3D imaging information of the object. The second type of light can be a flash type light for illuminating the scene of interest of the object. The flash-type of light can be optically expanded from a pulse light (e.g., laser pulse light) to cover the desired FOV (field of view). In another embodiment, the flash type of light can be generated by an array of light sources to cover the desired FOV. The desired FOV is defined by the scene of interest of the detection apparatus. In another embodiment, the second type of light may be a scanning light which can be light in multiple directions from multiple light sources or is generated by sweeping a light source in various directions across all of the desired FOV.

The detection apparatus 100 can determine the surface topography information of the object by continuously collecting the distance information to the object and the 3D imaging information of the object and stitching those together. In an embodiment, when a system with the detection apparatus 100 approaches the object to a suitable distance based on the distance information obtained by the ranging function, the detection apparatus 100 activates the area-sensing function to measure the 3D imaging information of the object for high detection precision and accuracy. For example, when a space landing aircraft performs the landing process, it first operates the ranging function (altimeter) to obtain distance information ranging from several kilometers to several hundred meters from the landing surface. When the space landing aircraft approaches the landing surface to a distance of about several hundred meters (e.g., 100˜300 meters), it switches to operate the area-sensing function to obtain 3D imaging information of the landing surface and stitch together the distance information and the 3D imaging information to form the surface topography information to find a flat and safe landing surface. In an embodiment, when a system with the detection apparatus 100 moves in its environment to detect a location, the detection apparatus 100 can perform SLAM (simultaneous localization and mapping) by comparing the present and previous surface topography information to recognize the current location.

The first light-emitting module 110 has a first housing 112, a first chamber 114 in the first housing 112, and a first light-emitting source 111 is located in the first chamber 114 and surrounded by the first housing 112. The first housing 112 has a first opening 113 aligned with the light-emitting direction of the first light-emitting source 111 for the light emitted by the first light-emitting source 111 to leave the first light-emitting module 110 toward the object. The first chamber 114 can be filled with air or encapsulation materials, such as silicone-based resin or epoxy-based resin. The first housing 112 is opaque to the light of the first light-emitting source 111 and can be used to protect the first light-emitting source 111 and prevent the light of the first light-emitting source 111 from leaking from the sides of the first light-emitting module 110. In another embodiment, the first light-emitting module 110 includes a transmissive plate (not shown) adhered to the first housing 112 to cover the first opening 113. The transmissive plate may be configured to protect the first light-emitting source 111 from contamination by dust and/or moisture, and/or serve as a filter or lens for the first light-emitting source 111 to collimate the light from the first light-emitting source 111.

The second light-emitting module 120 has a second housing 122, a second chamber 124 in the second housing 122, and a second light-emitting source 121 is located in the second chamber 124 and surrounded by the second housing 122. The second housing 122 has a second opening 123 aligned with the light-emitting direction of the second light-emitting source 121 for the light emitted by the second light-emitting source 121 to leave the second light-emitting module 120 toward the object. The second light-emitting source 121 can be configured to emit a flash type of light for area-sensing function. The second chamber 124 can be filled with air or encapsulation materials, such as silicone-based resin or epoxy-based resin. The second housing 122 is opaque to the light of the second light-emitting source 121 and can be used to protect the second light-emitting source 121 and prevent the light of the second light-emitting source 121 from leaking from the sides of the second light-emitting module 120. In another embodiment, the second light-emitting module 120 includes a transmissive plate (not shown) adhered to the second housing 122 to cover the second opening 123. The transmissive plate may be configured to protect the second light-emitting source 121 from contamination by dust and moisture, and/or serve as a filter or lens for the second light-emitting source 121 to collimate the light from the second light-emitting source 121.

The first light-emitting source 111 and the second light-emitting source 121 can be semiconductor laser elements, such as fiber laser, a laser diode, an edge emitting laser (EEL), a vertical-cavity surface-emitting laser (VCSEL), or photonic crystal surface emitting laser (PCSEL). In an embodiment, at least one of the first light-emitting source 111 and the second light-emitting source 121 includes a Q-switched (QS) laser, such as passive QS laser or active QS laser, to provide the high-power laser.

The light-receiving module 130 has a third housing 132, a third chamber 134 in the third housing 132, and a light detector 131 is located in the third chamber 134 and surrounded by the third housing 132. The third housing 132 has a third opening 133 aligned with the light detector 131 for receiving reflected light from the object. The third chamber 134 can be filled with air or encapsulation materials, such as silicone-based resin or epoxy-based resin. The third housing 132 is opaque to the lights from the first light-emitting source 111 and the second light-emitting source 121 and can be used to protect the light detector 131 and block the interference light. A lens 135 can be optionally adhered to the third housing 132 to cover the third opening 133. The lens 135 may be configured to protect the light detector 131 from contamination by dust and moisture, and/or collimate the reflected light for receipt by the light detector 131. The light detector 131 can include a plurality of photodetectors (e.g., photodiodes, time-of-flight (ToF) sensors, avalanche photodetectors (APD), single-photon avalanche diode (SPAD), etc.) to form a pixel array. The photodetector(s) of the light detector 131 may be discrete (e.g., a single photodiode) or an integrated array (e.g., a 1-D or 2-D array) for ToF (time of flight) sensing. For example, when the plurality of photodetectors include SPAD, the detection apparatus 100 can determine depth information associated with the object by comparing a timing where a SPAD generates an avalanche signal with a timing where a laser pulse was generated by the light-emitting module.

FIG. 1B shows a top view of a light detector in accordance with one embodiment of the present disclosure. The light detector 131 can be a ToF sensor (e.g., dToF) and includes a plurality of photosensitive regions 1313 to form a m×n pixel array. Each pixel may include one or more photosensitive regions and connect to associated biasing and/or control circuits, such as one or more quench circuits and/or TDC (time-to-digital converter) circuits. The light detector 131 has a first sub-array 1311 and a second sub-array 1312. Referring to FIGS. 1A and 1B, the first sub-array 1311 is located at the center of the light detector (light-receiving device) 131 and is surrounded by the second sub-array 1312. The first sub-array 1311 is configured to receive the reflected light of the first type of light L1 emitted by the first light-emitting module 110 for ranging, and the second sub-array 1312 is configured to receive the reflected light of the second type of light L2 emitted by the second light-emitting module 120 for area-sensing. The first type of light L1, such as pulsed laser light, has a small FOI and higher power intensity, which is suitable for long range detection. The second type of light L2, such as flash type laser, has a large emission angle and lower power intensity, which is suitable for area-sensing. Therefore, the first sub-array 1311 contains fewer pixels (or photosensitive regions) than the second sub-array 1312. For example, the light detector 131 contains 600×400 pixels, the first sub-array 1311 only contains 10×10 pixels, and the rest belongs to the second sub-array 1312. For long-range detection, each pixel can include a SPAD (single-photon avalanche diode) and the light detector 131 can be a dToF (direct Time-of-Flight) sensor. Each SPAD pixel corresponds to at least one photosensitive region of the light detector 131, which can detect weak light (down to a single photon) and generate a corresponding output signal due to an avalanche. When a photon impinging on a SPAD pixel is part of a reflection from an object of an emitted light, the detection apparatus can obtain the time at which the photon arrives at the SPAD pixel after emission based on the detection of the output signal. The detection apparatus can obtain distance or depth information to the object based on the time of flight between the arrival time and emitting time of the emitted light.

The light detector 131 includes a substrate composed of a first material (e.g., silicon) and a plurality of photosensitive regions supported by the substrate and composed of a second material (e.g., germanium) which can be different from the first material. Generally, germanium (or silicon-germanium compound) has a higher quantum efficiency than silicon at NIR and SWIR wavelength ranges. Moreover, germanium has a wider absorption spectrum range than silicon at NIR and SWIR wavelength ranges. Accordingly, comparing to InGaAs-based SWIR PD technology, germanium PD is compatible with CMOS processes, allowing the manufacture of the germanium PD as part of a CMOS production line. For example, Ge (germanium) PDs can be integrated into CMOS processes by growing Ge epilayers on a Si (silicon) substrate. For another example, Ge PDs can be integrated into CMOS processes by the wafer bonding process. Therefore, Ge PDs are also more cost effective than equivalent InGaAs PDs. In one embodiment, the detection apparatus 100 can operate in the SWIR band, which can avoid interference from ambient light caused by solar radiation. The photosensitive regions 1313 of the light detector 131 may contain GeSi, GeSn, SiGeSn, InGaAs, or InGaAsP to form the SWIR pixel array of the ToF sensor.

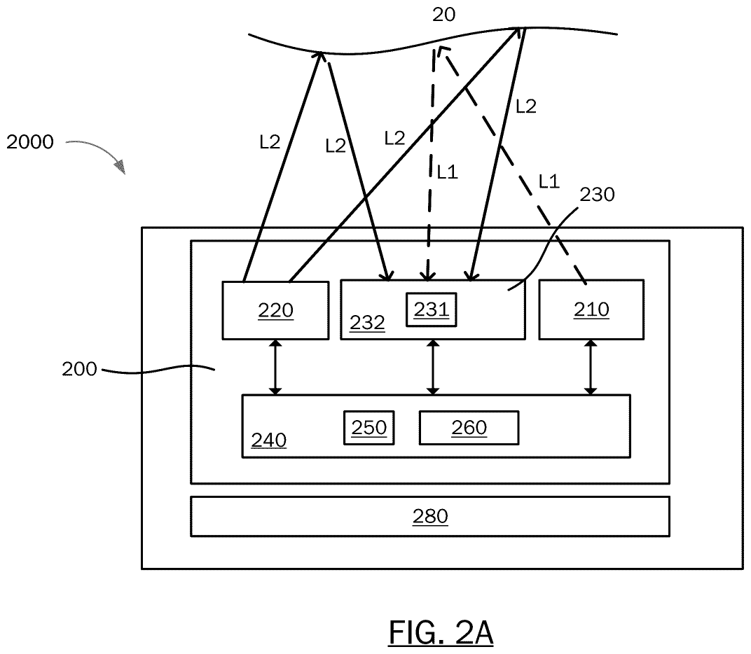

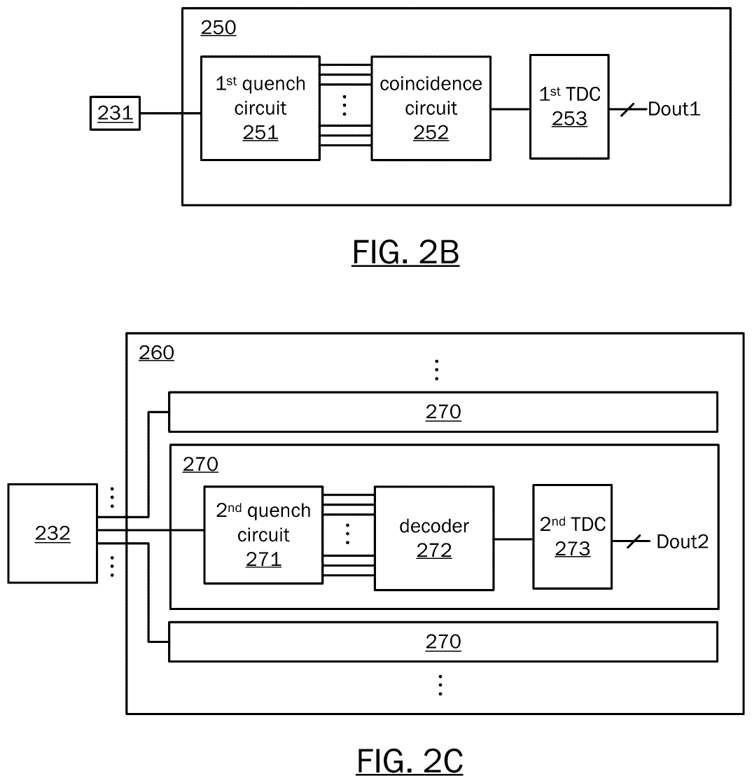

FIG. 2A shows a schematic of a vehicle including a detection apparatus in accordance with one embodiment of the present disclosure. The vehicle 2000 includes a detection apparatus 200 and a guiding element 280. The detection apparatus 200 includes a first emitter 210, a second emitter 220, a ToF sensor 230, and a processing circuit 240 coupling to the first emitter 210, the second emitter 220, and the ToF sensor 230. The first emitter 210 can be the aforementioned first light-emitting module 110 and is configured to emit a first type of light L1 (e.g., pulse laser light) toward the object 20 for ranging. The second emitter 220 can be the aforementioned second light-emitting module 120 and is configured to emit a second type of light L2 (e.g., flash laser light) toward the object 20 for area-sensing. The ToF sensor 230 can be the aforementioned light-receiving module 130 and includes a pixel array. The ToF sensor 230 is configured to receive the reflection of the first type of light L1 from the object 20 through the first sub-array 231 of the pixel array for ranging and the reflection of the second type of light L2 from the object 20 through the second sub-array 232 of the pixel array for area-sensing. The processing circuit 240 is configured to control the first emitter 210 and the second emitter 220 to emit light towards the object 20. The processing circuit 240 is also configured to process the output signals from the ToF sensor 230 to determine the results of the ranging and the area-sensing. At least a portion of the processing circuit 240 can be implemented in the aforementioned light-receiving module 130. In an embodiment, the processing circuit 240 can be implemented in the aforementioned light detector 131 and integrated with the pixel array through wafer-to-wafer bonding, die-to-wafer bonding, or die-to-die bonding technologies. The guiding element 280 is configured to guide the vehicle 2000 to find and/or reach the object.

The processing circuit 240 couples to the ToF sensor 230 and is configured to receive the output signals from the pixel array to determine the distance information for ranging and the 3D imaging information for the area-sensing process. The processing circuit 240 includes a first circuit 250 coupling to the first sub-array 231 of the pixel array of the ToF sensor 230 to process the output signals from the first sub-array 231 to determine the distance information for ranging. The processing circuit 240 includes a second circuit 260 coupling to the second sub-array 232 of the pixel array of the ToF sensor 230 to process the output signals from the second sub-array 232 to determine the 3D imaging information for area-sensing. The guiding element 280 is coupled to the processing circuit 240 to receive distance information, 3D imaging information, and/or surface topography information of the object 20. When the vehicle 2000 is far from the object 20, the processing circuit 240 activates the first emitter 210 and the ranging function of the first circuit 250. The guiding element 280 can guide the vehicle 2000 to reach the object 20 to a particular distance based on the distance information from the first circuit 250. The processing circuit 240 deactivates the second emitter 220 and the area-sensing function of the second circuit 260 until the vehicle 2000 has reached the particular distance to the object 20. Then, the processing circuit 240 can continuously collect the distance information and the 3D imaging information to determine the surface topography information of the object 20 by stitching together the distance information and the 3D imaging information. The guiding element 280 can guide the vehicle 2000 to the target zone or the destination according to the surface topography information. Each pixel of the ToF sensor 230 may include SPAD to detect an incident photon and generate the avalanche output in response to the incident photon.

FIG. 2B shows a schematic of a first circuit of the processing circuit of the detection apparatus in accordance with one embodiment of the present disclosure. The first circuit 250 coupling to the first sub-array 231 includes a first quench circuit 251 to quench a plurality of avalanche outputs corresponding to each pixel of the first sub-array 231. A coincidence circuit 252 couples to the first quench circuit 251 and is configured to receive the plurality of outputs from the first quench circuit 251 to perform the coincidence counting by detecting photons from several pixels arriving within a predetermined time to reduce interference from background photons (e.g., from ambient light sources or solar radiation) and enhance the accuracy of desired signal photons (e.g., from a desired light source). A first TDC (time-to-digital converter) 253 couples to the coincidence circuit 252 and is configured to measure the time between emission and the reception of the first type of light to determine the distance information for the ranging.

The second circuit 260 includes a plurality of sub-circuits, where each sub-circuit couples to each line of pixels (e.g., a row or a column) in the second sub-array 232. FIG. 2C shows a schematic of a second circuit of the processing circuit in accordance with one embodiment of the present disclosure. The second circuit 260 includes a plurality of sub-circuits 270, where each sub-circuit 270 couples to each line of pixels in the second sub-array 232. Each sub-circuit 270 includes a second quench circuit 271 to quench N avalanche outputs in the corresponding line of the second sub-array 232, where N represents the number of pixels in one line of the second sub-array 232. A decoder 272 couples to the second quench circuit 271 to scan N outputs from the second quench circuit 271. A second TDC 273 couples to the decoder 272 and is configured to receive the outputs of the decoder 272 to measure the time between emission and the reception of the light to determine the 3D image information for each pixel in the corresponding line of the pixel array. Therefore, the second circuit 260 includes a plurality of TDC output values to construct a depth map for each pixel in the second sub-array 232 to determine the 3D imaging information. Subsequently, the processing circuit 240 can continuously collect the distance information and the 3D image information to form the surface topography information of the object or to perform SLAM (simultaneous localization and mapping) to recognize the location.

In an embodiment, the first circuit 250 and the second circuit 260 integrate with the ToF sensor 230 to form a light detector disposed in the light-receiving module 130.

The vehicle 2000 can be a drone, a space landing aircraft, or other suitable system, such as autonomous driving, and mobile robots, can be installed the detection apparatus to detect the surface topography of objects. For example, the vehicle 2000 is a drone. When a drone operates the process of spraying pesticides, the detection device can first activate the ranging function to approach the target area. When the drone approaches the target area at a particular distance, it will activate the area-sensing function to detect the surface topography of the target area and position it to process the pesticide spraying operations. For another example, the vehicle is a space landing aircraft. When a space landing aircraft is seeking an area suitable for landing, it can first activate the ranging function to guide the space landing aircraft approaching the land. When the space landing aircraft approaches the land at around several hundred meters distance (e.g., 100˜300 meters), it will activate the area-sensing function to detect the surface topography of the land to seek a flat and safe landing surface.

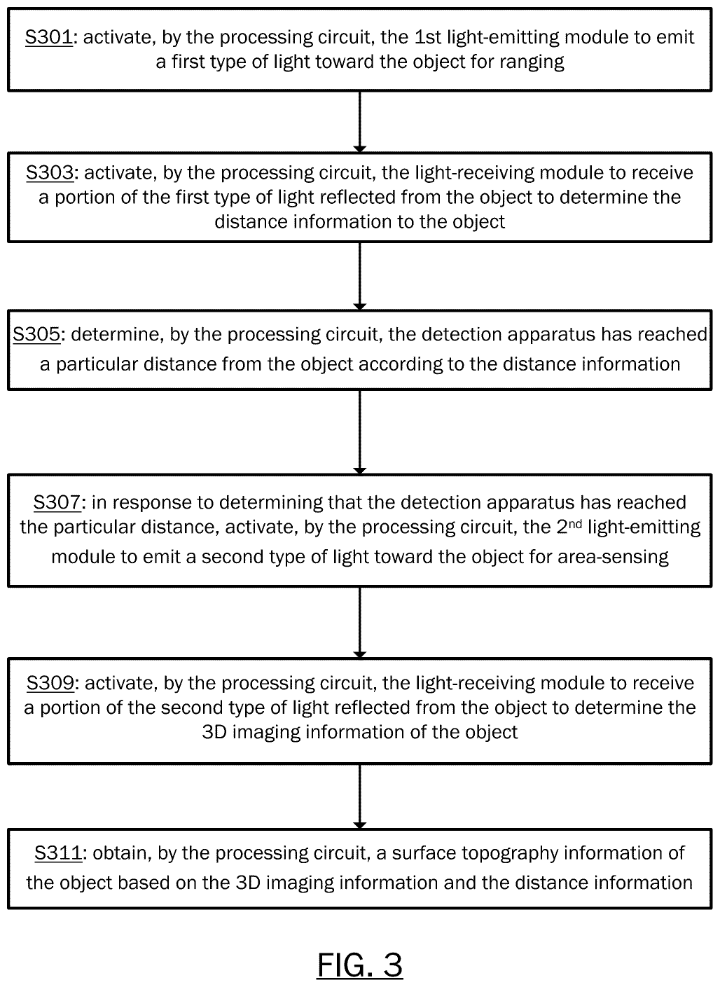

FIG. 3 shows a flow for determining a surface topography information of an object of a detection apparatus in accordance with one embodiment of the present disclosure. In step S301, the processing circuit can activate the first light-emitting module to emit a first type of light toward the object for ranging. The first type of light can be pulsed laser light for long-distance measurement. In step S303, the processing circuit can activate the light-receiving module to receive a portion of the first type of light reflected from the object to obtain the distance information to the object. In step S305, the processing circuit can determine the detection apparatus has reached the object to a particular distance (e.g., less than a predetermined value) according to the distance information. In step S307, in response to determining that the detection apparatus has reached the particular distance, the processing circuit can activate the second light-emitting module to emit a second type of light toward the object for area-sensing. The second type of light can be a flash type of light to illuminate the scene of interest of the object. The processing circuit may deactivate the second light-emitting module until the detection apparatus has reached the particular distance. In step S309, the processing circuit can activate the light-receiving module to receive a portion of the second type of light reflected from the object to obtain the 3D imaging information of the object. In step S311, the processing circuit can continuously collect the distance information and the 3D imaging information to obtain a surface topography information of the object based on the 3D imaging information and the distance information. A vehicle including the detection apparatus and a guiding element can be guided to a target zone or destination (e.g., landing zone) according to the surface topography information.

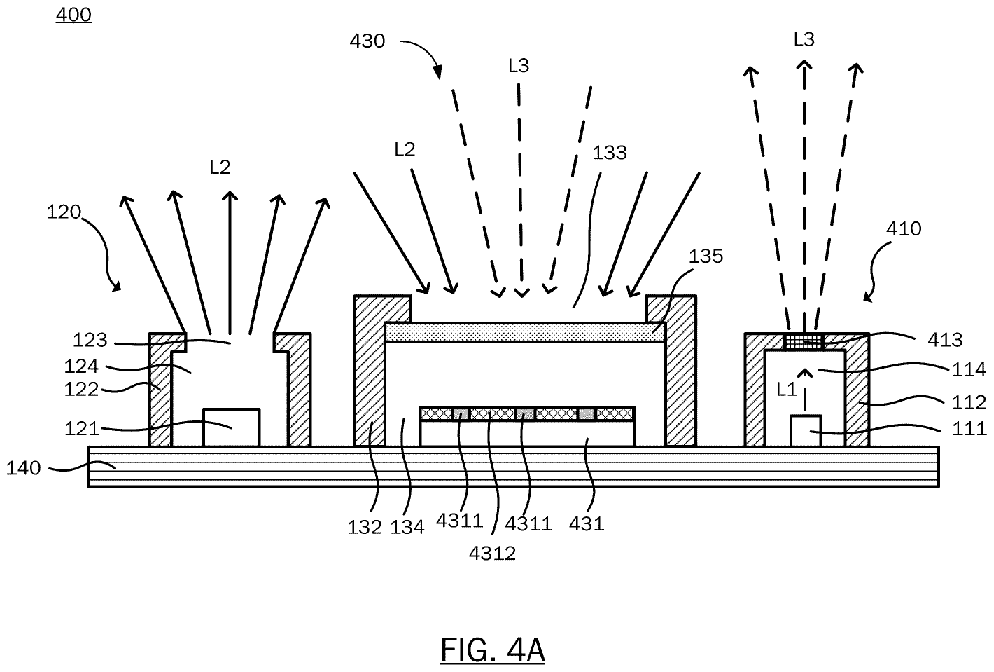

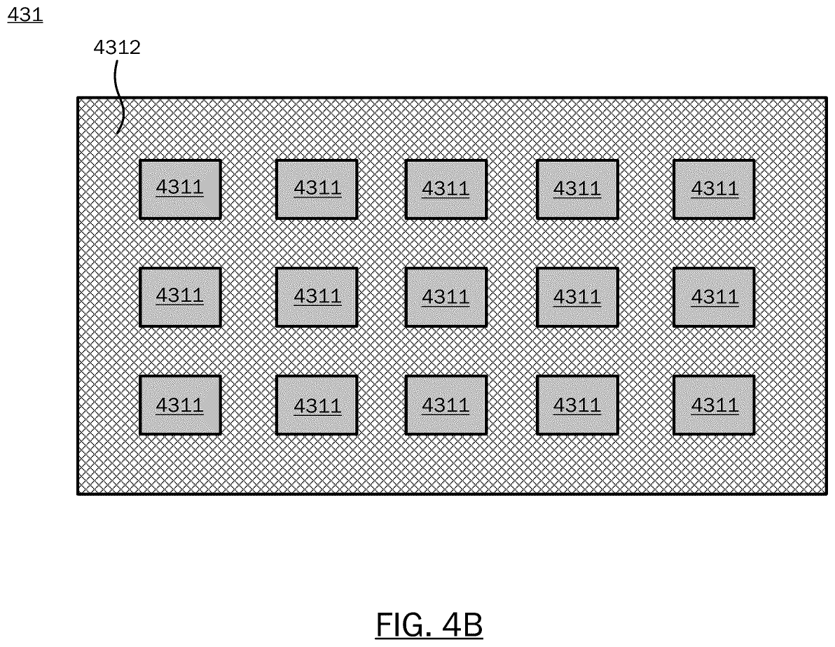

In another embodiment, the first type of light used for ranging can be split into array beams to detect a larger area. The light detector can include a plurality of first sub-arrays to receive array beams. FIG. 4A shows a view of a detection apparatus in accordance with another embodiment of the present disclosure. The detection apparatus 400 includes a first light-emitting module 410, a second light-emitting module 120, a light-receiving module 430, and a carrier 140. The second light-emitting module 120 and the carrier 140 are the same as those mentioned above in the detection apparatus 100. The first light-emitting module 410 is configured to emit the first type of light toward an object (not shown) for ranging. The first light-emitting module 410 is similar to the first light-emitting module 110 and may further include an optical element 413 disposed above the first light-emitting source 111 to split the first type of light LI from the first light-emitting source 111 into array beams L3 to detect a larger area. The optical element 413 can be a diffractive optical element (DOE) or a beam splitter. The light-receiving module 430 is configured to receive the reflected light of the array beams L3 from the first light-emitting module 410 for ranging and receive the reflected light of the second type of light L2 from the second light-emitting module 120 for area-sensing. The light-receiving module 430 is similar to the light-receiving module 130 and has a third housing 132, a third chamber 134 in the third housing 132, and a light detector 431 is located in the third chamber 134 and surrounded by the third housing 132. The light detector 431 can include a plurality of photodetectors to form a pixel array. The light detector 431 has a plurality of first sub-arrays 4311 for receiving the reflected light from the array beams emitted by the first light-emitting module 410. The light detector 431 has a second sub-array 4312 for receiving the reflected light of the light emitted by the second light-emitting module 120.

FIG. 4B shows a top view of a light detector 431 in accordance with one embodiment of the present disclosure. The light detector 431 can be a ToF sensor and includes a plurality of photosensitive regions to form a pixel array. Referring to FIGS. 4A and 4B, the plurality of first sub-arrays 4311 are formed as an array and surrounded by the second sub-array 4312. The plurality of first sub-arrays 4311 is configured to receive the reflected light of the first type of light emitted by the first light-emitting module 410 for ranging, and the second sub-array 4312 is configured to receive the reflected light of the second type of light emitted by the second light-emitting module 120 for the area-sensing. In an embodiment, the light detector 431 can include the first circuit 250 and the second circuit 260 integrated with the pixel array. The plurality of first sub-arrays 4311 can couple to the first circuit 250 as shown in FIGS. 2A˜2C to determine the distance information for ranging. The second sub-array 4312 can couple to the second circuit 260 as shown in FIGS. 2A˜2C to determine the 3D imaging information for the area-sensing.

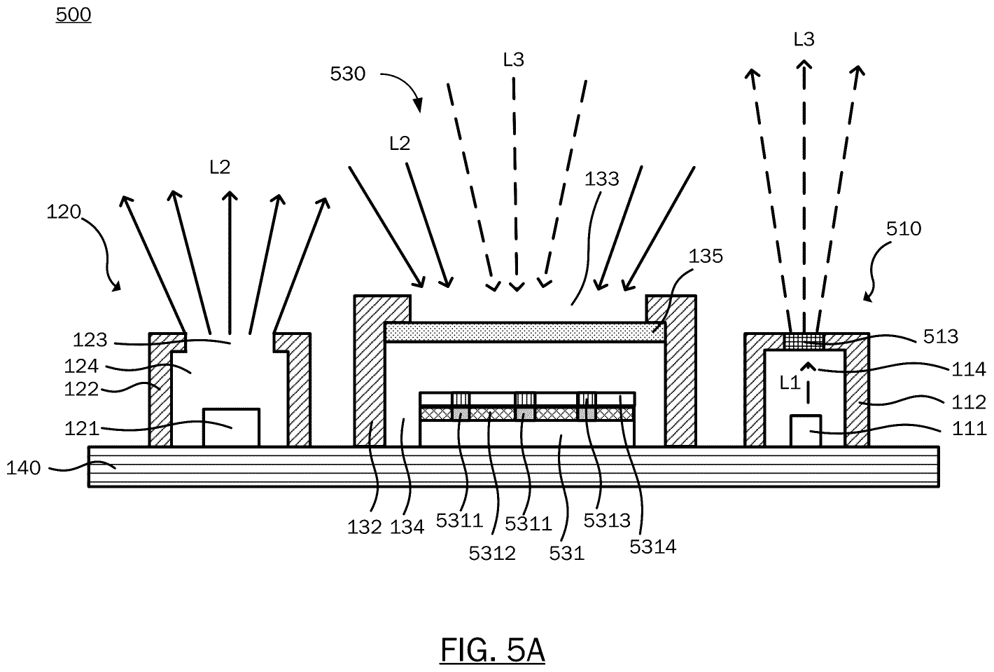

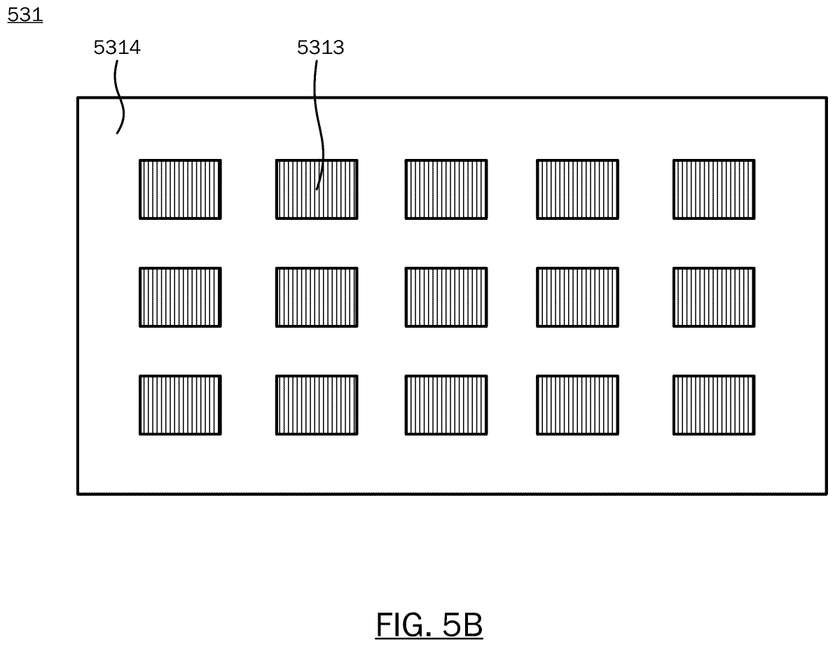

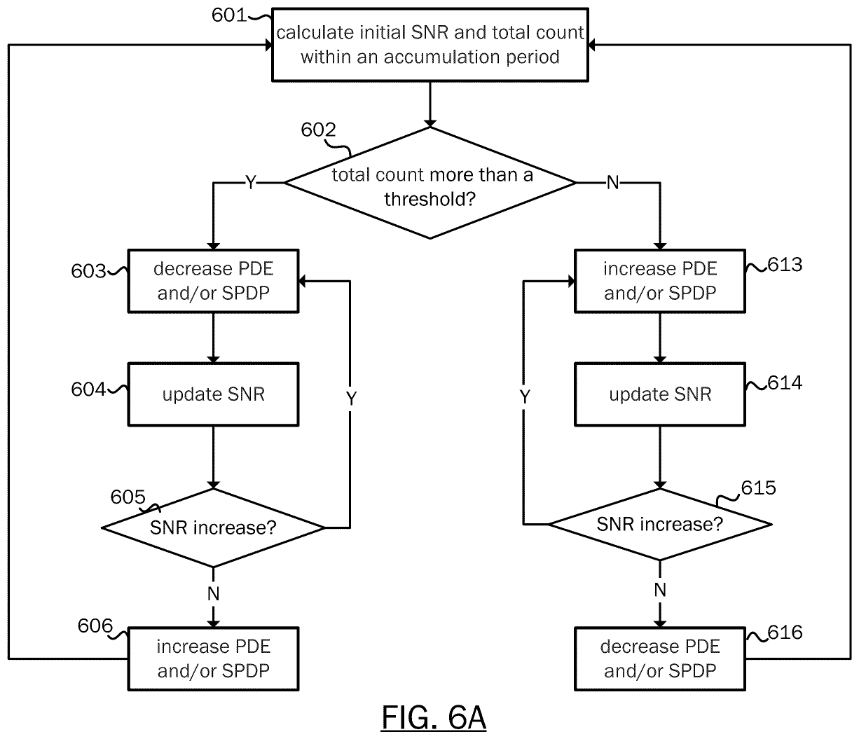

In another embodiment, the wavelengths of the first light-emitting module for ranging and the second light-emitting module for area-sensing can be different, to avoid the optical signal mutual interference between the ranging and area-sensing of the light-receiving module. FIG. 5A shows a view of a detection apparatus in accordance with another embodiment of the present disclosure. The detection apparatus 500 includes a first light-emitting module 510, a second light-emitting module 120, a light-receiving module 530, and a carrier 140. The second light-emitting module 120 and the carrier 140 are the same as those mentioned above in the detection apparatus 100. The first light-emitting module 510 can be used to emit the first type of light for ranging. The first light-emitting module 510 is similar to the first light-emitting module 410 and includes an optical element 513 disposed above the first light-emitting source 111 to split the first type of light L1 from the first light-emitting source 111 into array beams L3 to detect a larger area. The optical element 513 can be a diffractive optical element (DOE) or a beam splitter. The first light-emitting module 510 for ranging can emit light of a first wavelength, and the second light-emitting module 120 for area-sensing can emit light of a second wavelength different from the first wavelength. The light-receiving module 530 is configured to receive the reflected light of the array beams L3 from the first light-emitting module 110 for ranging and receive the reflected light of the second type of light L2 from the second light-emitting module 120 for area-sensing. The light detector 531 disposed in the light-receiving module 530 can include a plurality of photodetectors to form a pixel array. The light detector 531 has a plurality of first sub-arrays 5311 for receiving the reflected light from the array beams emitted by the first light-emitting module 510 and a second sub-array 5312 for receiving the reflected light of the light emitted by the second light-emitting module 120. The light detector 531 includes a plurality of first optical filters 5313 disposed over the plurality of first sub-arrays 5311 to remove the undesirable signal so that the plurality of first sub-arrays 5311 can receive the reflected light of the light with the first wavelength emitted from the first light-emitting module 510 for ranging. The light detector 531 includes a second optical filter 5314 disposed over the second sub-array 5312 to remove the undesirable signal so that the second sub-array 5312 can receive the reflected light of the light with the second wavelength emitted from the second light-emitting module 120 for area-sensing.

In an embodiment, the first wavelength for ranging can be in the SWIR band due to the absence of ambient light around 1135 nm or 1380 nm with ±10 nm deviation, as well as the weakening of ambient light around 1310 nm or 1550 nm with ±10 nm deviation. The second wavelength for area-sensing can also be in the SWIR band due to the highest solid-state laser power available around 1064 nm with ±10 nm deviation.

FIG. 5B shows a top view of a light detector 531 in accordance with one embodiment of the present disclosure. The light detector 531 can be a ToF sensor and includes a plurality of photosensitive regions to form a pixel array. Referring to FIGS. 5A and 5B, the plurality of first sub-arrays 5311 are formed as an array and surrounded by the second sub-array 5312. The plurality of first optical filters 5313 are formed as an array disposed over the plurality of first sub-arrays 5311 and corresponding to the plurality of first sub-arrays 5311. The second optical filter 5314 is disposed over the second sub-array 5312 and surrounds the plurality of first optical filters 5313. The plurality of first optical filters 5313 and the second optical filter 5314 can be an integrated filter. In an embodiment, the plurality of first optical filters 5313 and the second optical filter 5314 can be made of a meta-surface lens. In an embodiment, the light detector 531 can include the first circuit 250 and the second circuit 260 integrated with the pixel array. The plurality of first sub-arrays 5311 can couple to the first circuit 250 as shown in FIGS. 2A˜2C to determine the distance information for ranging. The second sub-array 5312 can couple to the second circuit 260 as shown in FIGS. 2A˜2C to determine the 3D imaging information for the area-sensing.

In general, the photon detection apparatus may need to operate with a high signal-to-noise ratio (SNR) for various ambient light conditions as well as a wide operational distance (i.e., scan range). For instance, by employing a plurality of Single Photon Avalanche Diodes (SPADs) as light detectors within the photon detection apparatus, it is possible to detect light at the single photon scale, which allows for high sensitivity of detection. Noise may come from ambient light sources, such as solar-generated photons, and/or from spurious dark counts generated internally by the SPADs. Several factors may influence the SNR. For example, the signal quality degrades as the distance to an object increases, so reducing the noise is an approach to improve SNR. Furthermore, SNR is related to photon detection efficiency (PDE) and single photon detection probability (SPDP) of the SPADs. If the PDE or SPDP of the SPADs is excessively high or low, the SPADs will not achieve optimal SNR. As the detection environment and the operating temperature of the SPADs may change, interference noise may also vary, thereby affecting the SNR of the photon detection apparatus. Consequently, the photon detection apparatus may have the capability to dynamically adjust the SNR to ensure that detection sensitivity remains good enough, regardless of environmental conditions, temperature variations, and other external factors.

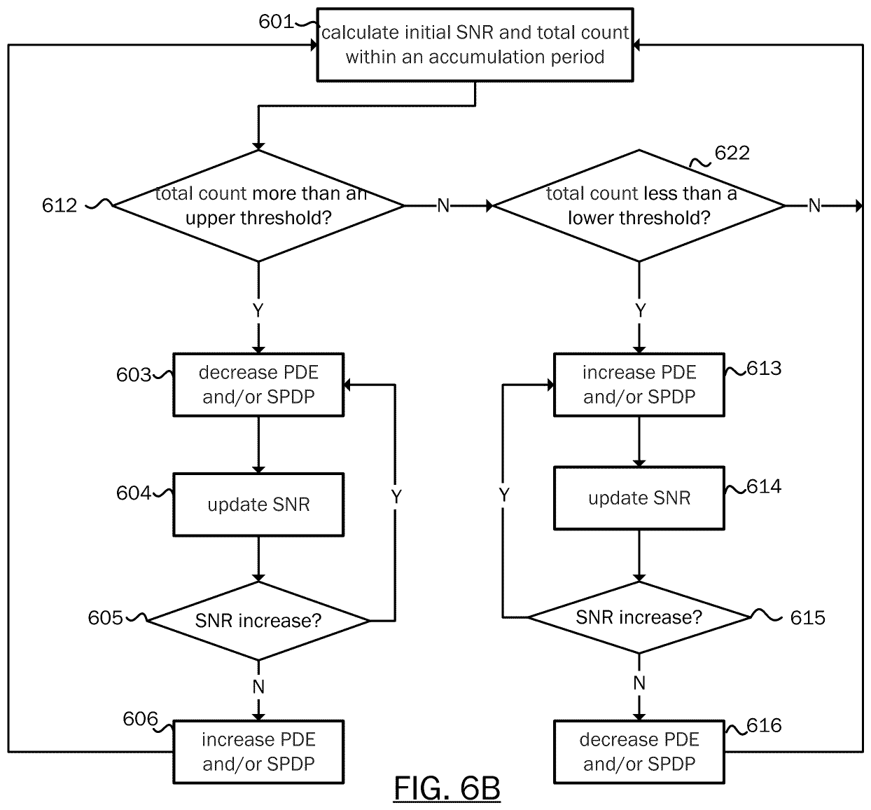

FIG. 6A shows a flow for adjusting the SNR of a detection apparatus in accordance with one embodiment of the present disclosure. The detection apparatus, such as the previously mentioned implementations, which may utilize Single-Photon Avalanche Diodes (SPADs), includes one or more processing circuits (e.g., processing circuit 240 in FIG. 2A) that utilize time-domain photon counting signals to derive detection results. In one implementation, the time-domain photon counting signals can be represented as histograms (e.g., dTOF histograms) through dTOF techniques. One or more processing circuits are coupled to the SPADs and are configured to determine the histogram over an accumulation period (e.g., multiple pulse cycles). The histogram serves to illustrate the relationship between the counts of photons detected by the SPADs in different time slots over the accumulation period. In an embodiment, the peak value appearing at a specific time slot in the histogram may be defined as the signal value (S), while the rest of values in other time slots may be defined as noise data. The noise value (N) can be derived by processing the noise data in the histogram through averaging, integration, summation, or other mathematical computations. Subsequently, one or more processing circuits are capable of calculating the SNR based on the signal value (S) and the noise value (N). The specific time slot where the peak value of the histogram is located can contain information regarding the distance and location of the object.

In step 601, one or more processing circuits of the detection device calculate the initial SNR and the total count in the histogram within the accumulation period (e.g., multiple pulse cycles). The initial SNR can be derived through the aforementioned method based on a histogram that represents the time-domain photon counting signals. The total count is obtained by summing the count values corresponding to all time slots in the histogram. In step 602, one or more processing circuits determine whether the total count is more than a threshold. If the total count is more than the threshold, it indicates that the light entering the SPADs is excessively high, which may lead to saturation of the SPADs and degrade the SNR. Consequently, in step 603, one or more processing circuits are configured to output a control signal to decrease the photon detection efficiency (PDE) and/or the single-photon detection probability (SPDP) of the SPADs, thereby reducing the detected counts. In step 604, after decreasing the PDE and/or SPDP of the SPADs, one or more processing circuits perform a calculation to update the SNR based on the current histogram and through the previously described method. In step 605, one or more processing circuits determine whether the SNR increases (e.g., the updated SNR is more than the initial SNR) based on the updated SNR. If the SNR increases, the process returns to step 603, where one or more processing circuits output a control signal to further decrease the PDE or SPDP of the SPADs. In step 606, if the SNR decreases, one or more processing circuits may generate a control signal to increase the PDE and/or SPDP of the SPADs and subsequently return to step 601 to repeat the adjustment procedure.

In step 602, one or more processing circuits determine whether the total count is more than a threshold. If the total count is not more than the threshold, it indicates that the light entering the SPAD is excessively low, which may need to enhance the SNR of the detection apparatus (or SPADs). Consequently, in step 613, one or more processing circuits are configured to output a control signal to increase the photon detection efficiency (PDE) and/or the single-photon detection probability (SPDP) of the SPADs, thereby increasing the detected counts. In step 614, after increasing the PDE and/or SPDP, one or more processing circuits perform a calculation to update the SNR based on the current histogram and through the previously described method. In step 615, one or more processing circuits determine whether the SNR increases (e.g., the updated SNR is greater than the initial SNR) based on the updated SNR. If the SNR increases, the process returns to step 613, where one or more processing circuits output a control signal to further increase the PDE or SPDP of the SPADs. In step 616, if the SNR decreases, one or more processing circuits may generate a control signal to decrease the PDE and/or SPDP of the SPADs and subsequently return to step 601 to repeat the adjustment procedure.

The process illustrated in FIG. 6A allows the detection device to achieve an optimal SNR by continuously adjusting the PDE and/or SPDP, ensuring precise detection results. However, the continuous adjustments require a certain amount of power consumption. In another embodiment, the detection device requires an adequate SNR, which may not be as good as optimal SNR, for practical use. Thereby, it allows for low power consumption while obtaining acceptable detection results. The process illustrated in FIG. 6B is similar to that of FIG. 6A, except that step 602 in FIG. 6A is replaced by step 612 and step 622, which determine whether the total count falls within a range between an upper threshold and a lower threshold. If the total count is within the range between the upper threshold and the lower threshold, there is no need to adjust the PDE and/or SPDP of the SPADs, as the SNR is adequate SNR.

As shown in FIG. 6B, after step 601, in step 612, one or more processing circuits determine whether the total count in the histogram is more than an upper threshold. If the total count is more than the upper threshold, it indicates that the light entering the SPADs is excessively high, which may lead to saturation of the SPAD and degrade the SNR. Consequently, one or more processing circuits perform the step 603. If the total count is not more than the upper threshold, as shown in step 622, one or more processing circuits determine whether the total count is less than a lower threshold. If the total count is less than the lower threshold, it indicates that the light entering the SPAD is excessively low, which may need to enhance the SNR of the detection apparatus (or SPADs). Then, one or more processing circuits perform the step 613. If the total count is neither more than the upper threshold nor less than the lower threshold, the total count is within an acceptable range to maintain an adequate SNR and the process returns to step 601. It should be noted that the sequence of steps 612 and 622 may be interchanged without impacting the overall process.

Methods for decreasing or increasing the Photon Detection Efficiency (PDE) and the Single-Photon Detection Probability (SPDP) of the SPADs may involve several adjustments. These adjustments include controlling the excess bias voltage applied to the SPADs, altering the focusing spot size in relation to a lens position, optimizing the light transmission efficiency of a variable attenuator, and/or modifying the lens iris.

For example, the excess bias voltage applied to the SPADs can influence the SPDP. For another example, focusing spot size of the lens impacts how concentrated the incoming photons are on the SPADs. For another example, the variable attenuators (e.g., Liquid Crystal, Liquid Crystal on Silicon (LCoS)) or the lens iris can dispose above the SPADs to adjust the light transmission efficiency to impact the PDE and/or the SPDP.

While the disclosure has been described by way of example and in terms of a preferred embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A detection apparatus configured to detect an object, comprising:
a first light-emitting module configured to emit a first type of light toward the object; and
a second light-emitting module configured to emit a second type of light toward the object;
a pixel array comprising a plurality of photodetectors, wherein the pixel array comprises a first sub-array configured to receive the first type of light and a second sub-array configured to receive the second type of light; and
a processing circuit comprising a first circuit coupled to the first sub-array and a second circuit coupled to the second sub-array, wherein the processing circuit is configured to:
activate the first light-emitting module to emit the first type of light toward the object;
process, by the first circuit and from the first sub-array, a portion of the first type of light reflected from the object to determine a distance information to the object;
determine that the detection apparatus has reached a particular distance from the object according to the distance information;
in response to determining that the detection apparatus has reached the particular distance, activate the second light-emitting module to emit the second type of light toward the object;
process, by the second circuit and from the second sub-array, a portion of the second type of light reflected from the object to determine a 3D imaging information; and
obtain a surface topography information of the object based on the distance information and the 3D imaging information.

2. The detection apparatus of claim 1, further comprising a guiding element configured to guide the detection apparatus to reach the particular distance from the object.

3. The detection apparatus of claim 2, wherein the guiding element determines a landing zone for a vehicle that includes the detection apparatus according to the surface topography information.

4. The detection apparatus of claim 1, wherein the processing circuit is configured to deactivate the second light-emitting module to emit the second type of light until the detection apparatus has reached the particular distance.

5. The detection apparatus of claim 1, wherein the pixel array, the first circuit, and the second circuit are integrated to form a light detector.

6. The detection apparatus of claim 1, wherein the pixel array is a time-of-flight sensor.

7. The detection apparatus of claim 1, wherein at least one of the first light-emitting module and the second light-emitting module includes a Q-switched laser.

8. The detection apparatus of claim 1, wherein the plurality of photodetectors comprises SPAD.

9. The detection apparatus of claim 1, wherein the plurality of photodetectors comprises germanium.

10. The detection apparatus of claim 1, wherein the first type of light is pulse light and the second type of light is flash type of light.

11. The detection apparatus of claim 1, wherein the first light-emitting module and the second light-emitting module operate in SWIR band.

12. The detection apparatus of claim 1, wherein the first light-emitting module comprises an optical element to split the first type of light into array beams for ranging.

13. The detection apparatus of claim 12, wherein the pixel array comprising a plurality of the first sub-array to receive a portion of the array beams reflected from the object.

14. The detection apparatus of claim 1, wherein the first type of light is at a first wavelength and the second type of light is at a second wavelength different from the first wavelength.

15. The detection apparatus of claim 1, wherein the first circuit comprises a first quench circuit, a coincidence circuit coupled to the first quench circuit, and a first time-to-digital converter coupled to the coincidence circuit to determine the distance information.

16. The detection apparatus of claim 15, wherein the second circuit comprises a plurality of sub-circuits corresponding to each line of the pixel array, each sub-circuit comprises a second quench circuit, a decoder coupled to the second quench circuit, and a second time-to-digital converter coupled to the decoder to determine the 3D imaging

17. A method for ranging and area-sensing by a detection apparatus, the method comprising:
activating, by a processing circuit, a first light-emitting module to emit a first type of light toward an object for ranging;
activating, by the processing circuit, a light-receiving module to receive a portion of the first type of light reflected from the object to determine a distance information to the object;
determining, by the processing circuit, the detection apparatus has reached a particular distance from the object according to the distance information;
in response to determining that the detection apparatus has reached the particular distance, activating, by the processing circuit, a second light-emitting module to emit a second type of light toward the object for area-sensing;
activating, by the processing circuit, the light-receiving module to receive a portion of the second type of light reflected from the object to determine 3D imaging information of the object; and
obtaining, by the processing circuit, a surface topography information of the object based on the 3D imaging information and the distance information.

18. The method of claim 17, further comprising deactivating, by the processing circuit, the second light-emitting module to emit the second type of light until the detection apparatus has reached the particular distance.

19. The method of claim 17, further comprising determining a landing zone for a vehicle that includes the detection apparatus according to the surface topography

20. The method of claim 17, wherein the light-receiving module comprises SPAD.
